(19) United States
(12) Patent Application Publication
(10) Pub. No.: US 2026/0053609 A1
(43) Pub. Date: Feb. 26, 2026

(54) SALIVA SUCTION TUBE STRUCTURE

(71) Applicants: SHU-CHENG LIN, Taipei City (TW); Ji-Jie Huang, Taipei City (TW)

(72) Inventors: SHU-CHENG LIN, Taipei City (TW); Ji-Jie Huang, Taipei City (TW)

(21) Appl. No.: 18/891,088

(22) Filed: Sep. 20, 2024

(30) Foreign Application Priority Data
Aug. 20, 2024 (TW) 113208963

(51) Int. Cl. A61C 17/06

(52) U.S. Cl. CPC A61C 17/06

(57) ABSTRACT

A saliva suction structure comprises an inner suction head with an inner fixing hole, a shrunk portion with a suction hole communicating with the inner fixing hole, and an outer hood covering the inner suction head and having an accommodation space. An upper end of the inner suction head is located at a lower end of the outer hood to form a spacing, a lower end of the outer hood is connected to a sleeve hole around the lower section of the inner suction head, two opposite sides of the outer hood are provided with a side hole separately, the top of the side hole is concavely formed at the top of the outer hood, the inner side of the inner fixing hole is provided with at least one convex buckle, and the inner fixing hole is provided with a tube body.

### BACKGROUND OF THE DISCLOSURE

### Technical Field

The present disclosure relates to an improved structure, and particularly relates to an improved saliva suction structure that can be adjusted and will not suck buccal mucosa.

### Description of the Related Art

With reference to FIGS. 1 and 2 for the exploded view and the cross-sectional view of a related-art product of a saliva suction tube 100 respectively, the saliva suction tube 100 is generally used by dentists on the market for dental treatment such as scaling, extraction, etc. to help removing water, saliva or other secretions from a patient's oral cavity and keeping the patient's mouth clean and dry, the saliva suction tube 100 is a medical device primarily used to collect saliva from a patient's oral cavity and water released as a result of flushing during dental treatment or flushing, and its structure mainly includes a tube body 1 and a suction head 2, the upper end of the tube body 1 is glued and fixed to the suction head 2, the inside of the tube body 1 is provided with a shaping line 11 which is in a fixed curved shape; the suction head 2 is in the shape of a hat and provided with a saliva suction space 20 inside the suction head 2, the lower end of the suction head 2 is provided with a fixing hole 21 communicating with the saliva suction space 20 and provided for adhering and fixing the tube body 1, the recession situated at the center of the upper end of the suction head 2 is provided with a taper 22, the center of the taper 22 is provided with a hole 221, the taper 221 and the periphery of the upper section of the suction head 2 are provided with a plurality of slits 23 communicating with the saliva suction space 20, the related-art product of the tube body 1 is connected to the suction device which generates a suction force. When the suction head 2 with sleeved with the tube body 1 is put into a patient's the oral cavity, the structure of the slits 23 around the outer periphery of the suction head 2 makes the suction head 2 unable to be rotated or adjusted on the tube body 1, and the buccal mucosa in the oral cavity will move, so that the suction head 2 will be securely sucked on the buccal mucosa inside the oral cavity and the buccal muscle on the inner side of the oral cavity, and the suction force around the suction head 2 will disappear, so that it is necessary to repeat the action of pulling out, making an adjustment for one time, and then making another adjustment for one time, or else a large amount of flushing water used for scalping or extraction will accumulate in the oral cavity, which causes choking and discomfort to the patient and great inconvenience to doctors and assistants in operating and using the device, and greatly reduces the practicality. The aforementioned deficiency of the related art demands immediately attention and feasible solutions.

### SUMMARY OF THE DISCLOSURE

The primary objective of the present disclosure is to overcome the aforementioned technical deficiency by providing a saliva suction structure, which includes an inner suction head, an outer hood, and a shrunk portion extending from an upper section of the inner suction head, wherein the outer hood covers the outer side of the inner suction head and has a side hole formed on two opposite sides separately, and the inner suction head is provided with a tube body, in order to overcome the difficulties in the existing technology.

The secondary objective of the present disclosure is to provide a saliva suction structure, which uses the inner part of the outer hood and the inner suction head with the shrunk portion in the upper section to generate a strong suction force, and there is a spacing between the outer hood and the top of the shrunk portion, and side holes are formed on two sides of the outer hood and the outer hood top is concavely formed at their upper end, which can be adjusted quickly and with little effort, to avoid the buccal mucosa of the oral cavity from being wrapped up and to prevent the disappearance of the suction force and the choking injury caused by the water and saliva accumulated in the oral cavity.

A further objective of the present disclosure is to provide a saliva suction structure, which effectively improves the ease of use and safety.

The problem that the present disclosure is intended to solve is that the structure of the related-art product includes a tube body and a suction head, the suction head has a saliva suction space inside and a taper located at the central depression of the upper end, and the upper section of the taper and the periphery of the suction head are surrounded with a plurality of slits which communicates with the saliva suction space, the related-art product of the suction head 2 cannot be rotated or adjusted on the tube body 1, the suction head will be sucked on the buccal mucosa inside the oral cavity and the buccal muscle on the inner side of the oral cavity, making the suction force of the suction head disappear, and it is necessary to repeat the action of pulling out the suction heard and making an adjustment, and the related-art product will cause water to accumulate in the oral cavity and cause the patient to choke on the suction head and cause discomfort, and it is inconvenient to use and operate the saliva suction tube, which significantly reduces its practicality.

To achieve the aforementioned objective, the present disclosure provides a saliva suction structure, the saliva suction tube, including: an inner suction head, with an inner fixing hole formed at a lower end thereof, a shrunk portion extending from an upper section of the inner suction head, and a suction hole formed at the middle of the upper end of the shrunk portion and communicating with the inner fixing hole; and an outer hood, covering an outer side of the inner suction head, and having a top located at an upper end of the outer hood, an accommodation space defined in the outer hood for accommodating the inner suction head, an upper end of the inner suction head disposed at a lower end of the outer hood and formed with a spacing, a lower end of the outer hood being provided with a sleeve hole communicating with the accommodation space and coupled to the outer periphery of the lower section of the inner suction head, two opposite sides of the outer hood, the shrunk portion disposed at the inner suction head and the spacing being provided with a side hole separately, and the top of the side hole is concavely formed at the top of the outer hood.

In the present disclosure, the shrunk portion of the inner suction head is in an inversely tapered shape.

In the present disclosure, he shrunk portion of the inner suction head is in a conical shape.

In the present disclosure, the inner side of the inner fixing hole of the inner suction head is provided with at least one convex buckle.

In the present disclosure, the convex buckle of the inner suction head is in a triangular shape or semicircular shape.

In the present disclosure, the top of the outer hood is in a planar shape, a circular arc shape, a conical shape or a polygonal shape.

In the present disclosure, the inner fixing hole of the inner suction head is provided with a tube body.

In the present disclosure, the inside of the tube body is provided with at least one shaping line which is in a fixed curved shape.

Compared with the effects of the related art, the present disclosure includes the inner suction head, the outer hood, the shrunk portion extending from the upper section of the inner suction head, the outer hood covering the outer side of the inner suction head and having the side holes formed on two opposite sides, and the inner suction head is provided with the tube body; such that the inside of the outer hood and the upper section of the inner suction head with the shrunk portion generate a strong suction force, the spacing is formed between the outer hood and the shrunk portion top, and the side holes on two sides of the outer hood and the top of the outer hood concavely formed in their upper ends are provided to form a spacing, so that the angle can be adjusted quickly and effortlessly to avoid the buccal mucosa of the oral cavity from being wrapped up and to prevent the disappearance of the suction force and the choking injury caused by the water and saliva accumulated in the oral cavity, so as to effectively improve the ease of use and safety, in line with the practical use and user needs.

### BRIEF DESCRIPTION OF THE DRAWINGS

FIG. 1 is a schematic view showing the disassembled structure of a related-art product;

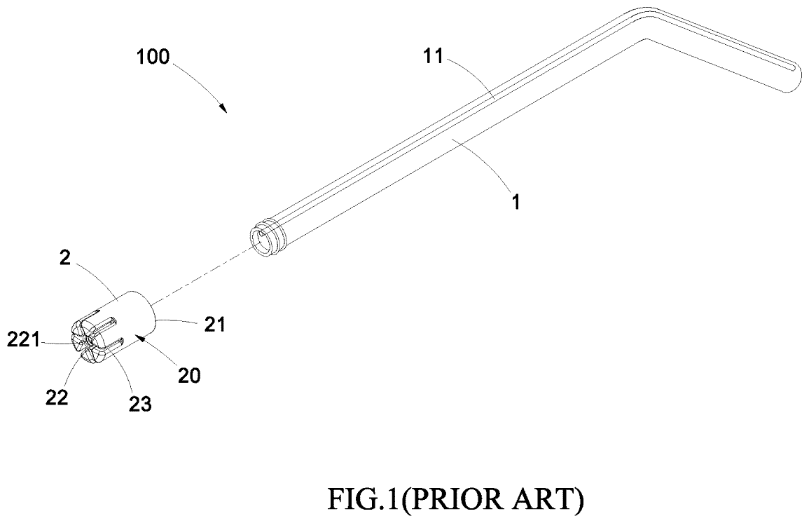

FIG. 2 is a cross-sectional view showing the assembled structure of a related-art product;

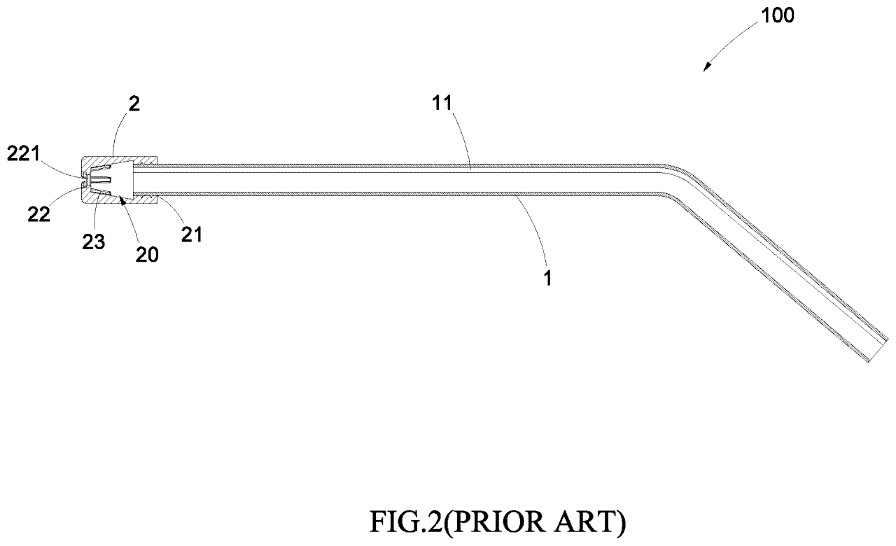

FIG. 3 is a schematic view showing the disassembled structure of the present disclosure;

FIG. 4 is a perspective view of the present disclosure; and

FIG. 5 is a cross-sectional view of the present disclosure.

### DESCRIPTION OF THE PREFERRED EMBODIMENTS

The objectives, technical contents and features of this disclosure will become apparent in the following detailed description of the preferred embodiments with reference to the accompanying drawings. It is noteworthy that the drawings used in the specification are only intended for illustrating the present disclosure, and may not represent the actual proportions and precise configurations after implementation of the present disclosure. Therefore, the proportions and configuration relationships of the accompanied drawings should not limit the scope of the present disclosure.

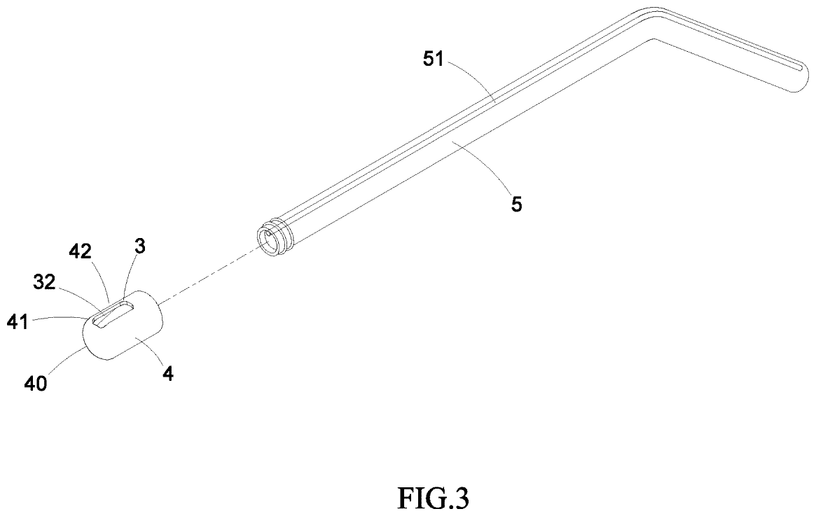

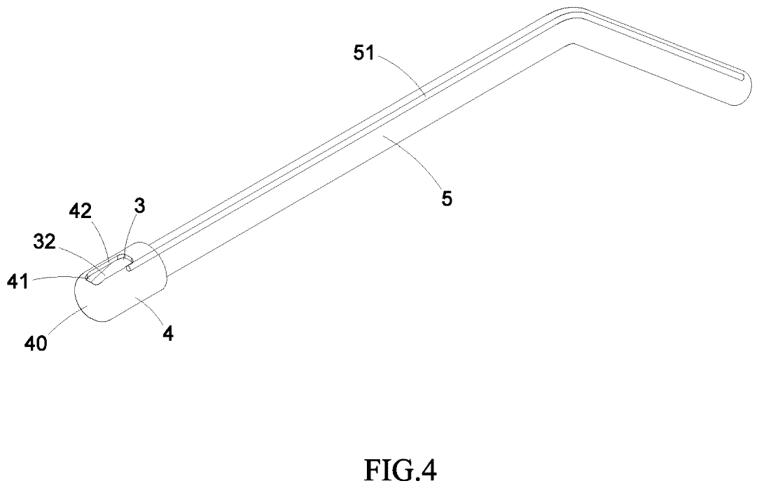

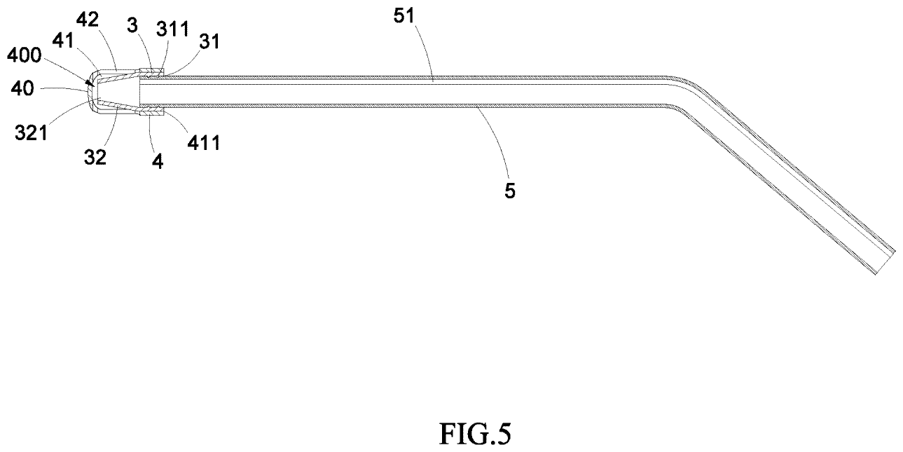

With reference to FIGS. 3, 4 and 5 for the disassembled view, the perspective view and the cross-sectional view of saliva suction structure in accordance with an embodiment of the present disclosure respectively, the saliva suction structure is a saliva suction tube 300 including an inner suction head 3 and an outer hood 4.

The inner suction head 3 has an inner fixing hole 31 formed at its lower end, and a shrunk portion 32 extending from the upper section of the inner suction head 3 and having a suction hole 321 formed at the middle of the upper end of the shrunk portion 32 and communicating with the inner fixing hole 31. In the present disclosure, the shrunk portion 32 of the inner suction head 3 is in an inversely tapered shape to increase the flow velocity for the suction hole 321 in order to generate a strong suction force; the shrunk portion 32 of the inner suction head 3 is in a conical shape, but the present disclosure is not limited to this shape only; the inner side of the inner fixing hole 31 of the inner suction head 3 is provided with at least one convex buckle 311, and there are two convex buckles 31 in this embodiment, but the present disclosure is not limited to this quantity only; and the convex buckle 311 of the inner suction head 3 is in a triangular shape or a semicircular shape, but the present disclosure is not limited to this shape only.

The outer hood 4 covers the outer side of the inner suction head 3, the upper end of the outer hood 4 has a top 40, the inside of the outer hood 4 has an accommodation space 41 for accommodating the inner suction head 3, the upper end of the inner suction head 3 is located at the lower end of the outer hood 4 to form a spacing 400, the lower end of the outer hood 4 has a sleeve hole 411 communicating with the accommodation space 41 and connected to the lower section of the inner suction head 3, the top of the outer hood 4 is in a planar shape, a circular arc shape, a conical shape or a polygonal shape, but the present disclosure is not limited to this shape only, two opposite sides of the outer hood 4 have a side hole 42 formed at the shrunk portion 32 of the inner suction head 3 and the spacing 400 separately, the top of the side hole 42 is concavely formed at the top 40 of the outer hood 4, in order to avoid that when the side hole 42 of the outer hood 4 is covered, there is still a gap provided for the shrunk portion 32 of the inner suction head 3 to allow air to enter the suction hole 321, which will not cause the saliva suction tube of the present disclosure to generate a vacuum suction or to be adhered to the buccal mucosa of the oral cavity and unable to be pulled out.

In the present disclosure, the inner fixing hole 31 of the inner suction head 3 has a tube body 5, which is stuck and rotatable, the inside of the tube body 5 has at least one shaping line 51 which is in a fixed curved shape, and the tube body 5 is connected to the suction device for generating a suction force.

In the present disclosure, the inner suction head 3 has the shrunk portion 32 at the upper section of the saliva suction tube, and the outer hood 4 covering the outside of the inner suction heard, two sides of the outer hood 4 are provided with the side hole 42, the lower end of the inner suction head 3 is provided with the inner fixing hole 31 sheathed and fixed to the tube body 5; the tube body 5 is connected to the suction device to allow air to enter the accommodation space 41 inside the outer hood 4 from the side hole 42 of the outer hood 4 and to reach the inner suction head 3 from the suction hole 321 at the top of the shrunk portion 32 and the tube body 5 at the lower end of the inner suction head 3. In addition, the outer hood 4 only uses the side holes 42 on both sides, and in the main time, the upper ends of the side holes 42 are concavely formed at the top of the outer hood 4 to produce a gap to allow users to adjust the tube body 5 conveniently and fix the angle of the inner suction head 3 of the shrunk portion 32 relative to the outer hood 4, such that the buccal mucosa on the buccal muscles inside the oral cavity will not be covered or wrapped up, and the suction force will not disappear unexpectedly.

The present disclosure includes the inner suction head 3, the outer hood 4, the shrunk portion 32 extending from the upper section of the inner suction head 3, the outer hood 4 covering the outer side of the inner suction head 3 and two opposite sides are provided with the side holes 42 respectively, and the inner suction head 3 is provided with the tube body 5; the inside of the outer hood 4 and the upper section of the inner suction head 3 having the shrunk portion 32 generates a strong suction force, the spacing 400 is formed between the outer hood 4 and the top of the shrunk portion 32, and the side holes 42 on two sides of the outer hood 4 and their upper end concavely formed at the top of the outer hood 4 to form a gap, so that the angle can be adjusted quickly and effortlessly to avoid the buccal mucosa of the oral cavity from being wrapped up and to prevent the disappearance of the suction force and the choking injury caused by the water and saliva accumulated in the oral cavity, so as to effectively improve the ease of use and safety, in line with the practical use and user needs.

In summation of the description above, the present disclosure breaks through the technical structure of the related art and surely achieve the expected improvement. The present disclosure complies with the patent application requirements and is thus duly filed for patent application.

While the present disclosure is described in some detail hereinbelow with reference to certain illustrated embodiments, it is to be understood that there is no intent to limit the disclosure to those embodiments. On the contrary, the aim is to cover all modifications, alternatives and equivalents falling within the spirit and scope of the invention as defined by the appended claims.

What is claimed is:

1. A saliva suction structure, comprising:
an inner suction head, with an inner fixing hole formed at a lower end thereof, a shrunk portion extending from an upper section of the inner suction head, and a suction hole formed at the middle of the upper end of the shrunk portion and communicating with the inner fixing hole; and
an outer hood, covering an outer side of the inner suction head, and having a top located at an upper end of the outer hood, an accommodation space defined in the outer hood for accommodating the inner suction head, an upper end of the inner suction head disposed at a lower end of the outer hood and formed with a spacing, a lower end of the outer hood being provided with a sleeve hole communicating with the accommodation space and coupled to the outer periphery of the lower section of the inner suction head, two opposite sides of the outer hood, the shrunk portion disposed at the inner suction head and the spacing being provided with a side hole separately, and the top of the side hole is concavely formed at the top of the outer hood.

2. The saliva suction structure according to claim 1, wherein the shrunk portion of the inner suction head is in an inversely tapered shape.

3. The saliva suction structure according to claim 2, wherein the shrunk portion of the inner suction head is in a conical shape.

4. The saliva suction structure according to claim 1, wherein the inner side of the inner fixing hole of the inner suction head is provided with at least one convex buckle.

5. The saliva suction structure according to claim 4, wherein the convex buckle of the inner suction head is in a triangular shape or a semicircular shape.

6. The saliva suction structure according to claim 1, wherein the top of the outer hood is in a planar shape, a circular arc shape, a conical shape or a polygonal shape.

7. The saliva suction structure according to claim 1, wherein the inner fixing hole of the inner suction head is provided with a tube body.

8. The saliva suction structure according to claim 7, wherein the inside of the tube body is provided with at least one shaping line which is in a fixed curved shape.

9. The saliva suction structure according to claim 2, wherein the inner fixing hole of the inner suction head is provided with a tube body.

10. The saliva suction structure according to claim 3, wherein the inner fixing hole of the inner suction head is provided with a tube body.

11. The saliva suction structure according to claim 4, wherein the inner fixing hole of the inner suction head is provided with a tube body.

12. The saliva suction structure according to claim 5, wherein the inner fixing hole of the inner suction head is provided with a tube body.

13. The saliva suction structure according to claim 6, wherein the inner fixing hole of the inner suction head is provided with a tube body.
